(19) United States
(12) Patent Application Publication
(10) Pub. No.: US 2006/0057176 A1
(43) Pub. Date: Mar. 16, 2006

(54) Easy-to-use biocidal/virucidal compositions

(76) Inventors: Mark Wallace Squire, Suffolk (GB); Vincent Brian Croud, Yorkshire (GB)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/224,619

(22) Filed: Sep. 12, 2005

Related U.S. Application Data
(60) Provisional application No. 60/610,442, filed on Sep. 15, 2004.

(51) Int. Cl. A01N 59/08; A01N 25/00

(52) U.S. Cl. 424/405; 424/661

(57) ABSTRACT

A tableted biocidal/virucidal composition comprising (a) 0.01 to 5 parts by weight of a water soluble inorganic halide, (b) 25 to 60 parts by weight of an oxidizing agent, (c) 3 to 8 parts by weight of sulfamic acid, (d) up to about 10 parts by weight of an anhydrous alkali metal phosphate, (e) 5 to 25 parts by weight of a water-soluble carbonate or bicarbonate, and (f) a non-reducing organic acid in an amount sufficient that the pH of a 1% by weight aqueous solution of the composition is between 1.5 and 3.5; the parts by weight of the composition totaling 100, wherein a 5 gram tablet of the composition dissolves in 500 ml of water in less than 8 minutes at ambient temperature. Solutions of the composition in tablet form dissolved in a polar solvent provide a liquid disinfecting agent that is useful in sanitizing hard surfaces.

### FIELD OF THE INVENTION

The present invention generally relates to biocidal and virucidal compositions that are provided in the form of effervescent tablets.

### BACKGROUND OF THE INVENTION

Hypochlorites, in the form of liquid sodium hypochlorite (domestic bleach) or calcium hypochlorite (bleach powder), and materials such as trichlorocyanuric acid and Chloramine T, have been used for many years as bleaching and sanitizing agents for domestic, industrial and to a lesser extent, farm use. These products are marketed as powders and liquids—principally powders—and have a pH in use ranging from 7 to 11. They all suffer from deficiencies. Liquid products are corrosive, unstable, and readily inactivated by organic matter, thus limiting their usefulness and reliability, particularly under farm conditions where large quantities of organic matter are encountered. Powder products are more stable, but are much less reactive. Chloramine T, for example, requires extremely high concentrations to produce an acceptable biocidal effect, and in addition, its activity is seriously affected by organic matter.

Because the products are offered in alkaline or neutral formulations their virucidal activity is severely restricted. It is well known that acidity contributes to lethality toward viruses. Viral disease is of particular significance in animal health due to the close quarters in which farm animals are kept, which facilitates spread of virus. For this purpose, the ideal virucidal system should be acidic in nature, and at an in-use dilution which preferably provides a solution with a pH of about 2-4. However, many conventional hypochlorite solutions over this range of pH liberate chlorine gas from hypochlorite source, and therefore, it has not been possible to date to obtain enhanced virucidal properties.

There is extensive prior art dealing with formulations which set out to achieve stable acidic systems. Formulations made in accordance with those claimed in UK Patent 932750 are highly unstable in the powder state and liberate chlorine gas within a short period of manufacture. This is due principally to the use of high concentrations of sulfamic acid and mineral acid salts added to achieve the desired level of acidity. The use of mineral acid boosters to the sulfamic acid, which is present as a chlorine acceptor and stabilizer, besides introducing instability into the formulation, also causes the formulation to be highly corrosive.

UK Patent 2078522 sought to overcome the deficiencies of UK Patent 932750 by using the minimum level of sulfamic acid as a chlorine acceptor and achieving the desired level of acidity at in-use dilution using a non-reducing organic acid such as malic acid or succinic acid or, alternatively, an acid phosphate salt in combination with the sulfamic acid acceptor. This produces a relatively stable powder system which does not liberate chlorine gas when stored for prolonged periods at 37° C., nor does it liberate chlorine as detected by odor when the product is dissolved in water at approved appropriate dilutions. However, chlorine is liberated if the product is stored under damp conditions, or if instructions are not followed and concentrated solutions are prepared.

UK Patent 2164851 addressed problems of chlorine liberation upon storage under damp conditions by replacing hypochlorite with a mixture of inorganic chloride and an oxidizing agent, which generates hypochlorite ions in aqueous solution. U.S. Pat. No. 4,822,512 provided a further improvement by careful control of the composition. A dry, particulate, water-soluble biocidal composition is disclosed therein comprising: (a) 0.01-5 parts by weight of a water-soluble inorganic halide; (b) 25-60 parts by weight of an oxidizing agent; (c) 3-8 parts by weight of sulfamic acid; (d) up to 20 parts by weight of a non-reducing organic acid; and (e) 10-30 parts by weight of an anhydrous alkali metal phosphate; the pH of a 1% by weight aqueous solution of the composition being between 1.2 and 5.5.

Such compositions have proven particularly useful, but their physical form—that of a dry, particulate powder-like material—is not as convenient as it might be. For example, the phenomenon of “dusting” is well known whereby the powder gives a primary irritant effect which can cause eye damage, etc. While such compositions can be packaged for individual doses, packaging, for example, in individual sachets, adds costs and difficulties to production. Foil sachets are known but are difficult to manufacture and may break, causing storage stability problems. Also, foil sachets are not biodegradable. Water-soluble sachets are an alternative to foil sachets and may be biodegradable, but use of such sachets also adds costs. In addition, water-soluble sachets may not fully dissolve, which limits use of the compositions in trigger spray bottles where undissolved film can block the outlet of the spray nozzle.

It is therefore common practice to produce powder compositions in tablet form. Tablets have several advantages, such as accurate measured dosage, avoidance of “dusting”, centralized, easy no-weigh dispersing, and ease of stock control and usage control. The principal use of such tablets is in hospitals because in the medical field there is a particularly great need for accurately measured dosage.

It is convenient to incorporate within a tableted formulation reagents which react together when the tablet is placed in water, to generate carbon dioxide—to effervesce. Effervescence assists in the disintegration of the tablet and in the solubilization of the other tablet ingredients. Typical reagents which are chosen for this purpose are sodium bicarbonate and an organic acid, for example, citric, adipic, or tartaric acid. However, when these organic acids are employed, the sodium salts formed by the reaction—citrates, adipates, or tartrates—being weak acid salts of strong bases, function as buffering agents, stabilizing the solution pH at a relatively high value, and, accordingly, it is not possible to obtain solutions which have the low pH that is of particular importance virologically.

WO 91/03936 discloses a tablet formulation of a wide-spectrum biocidal preparation, comprising a water-soluble halide, a strong oxidizing agent, sulfamic acid to act as chlorine acceptor, a water soluble carbonate or bicarbonate, wherein sulfamic acid is present in sufficient excess to react with the carbonate or bicarbonate to produce carbon dioxide for the desirable effervescence. This tablet composition can have solubility and stability problems. The addition of carbonate or bicarbonate to the composition increases pH. Compensating by addition of sulfamic acid reduces solubility of the tablet composition and further reduces life of the actives in solutions prepared from the tablets as compared to solutions prepared from powders based on U.S. Pat. No. 4,822,512.

There remains a need for a composition in tablet form that is stable and soluble while providing high biocidal, virucidal activity. The present invention meets these needs.

### SUMMARY OF THE INVENTION

The present invention is directed to a biocidal composition in a tablet form comprising
(a) 0.01 to 5 parts by weight of a water soluble inorganic halide;
(b) 25 to 60 parts by weight of an oxidizing agent;
(c) 3 to 8 parts by weight of sulfamic acid;
(d) up to 10 parts by weight of an anhydrous alkali metal phosphate;
(e) 5 to 25 parts by weight of a water-soluble carbonate or bicarbonate; and
(f) a non-reducing organic acid in an amount sufficient that the pH of a 1% by weight aqueous solution of the composition is between 1.5 and 3.5;
the parts by weight of the composition totaling 100, wherein a 5 gram tablet of the composition dissolves in 500 ml of water in less than 8 minutes at ambient temperature.

The tablet form of the present invention avoids disadvantages of powders such as dusting and packaging in foil or water-soluble sachets. The tablets also provide low pH to improve performance as a biocidal/virucidal agent. A tablet of this invention provides a stable solution once dissolved. For example, a 1% solution prepared from a tablet of this invention retains 70% or more actives over at least 7 days.

It has been found that careful control of ingredients, in particular those which affect pH in solution, is required to provide a biocidal/virucidal composition in tablet form that readily dissolves and retains actives upon storage of the solution.

The solid composition is soluble in polar solvents, especially water, and provides a stable solution in said solvents.

The solutions of the invention have biocidal activity at low concentrations of composition dissolved in a solvent. A mixture ratio of about 1 gram of composition to about 100 ml of solvent produces a solution that has strong, broad-spectrum biocidal activity.

The solutions of the invention can comprise solid compositions of the invention and one or more polar solvents, surfactants and binders.

### DETAILED DESCRIPTION OF THE INVENTION

Trademarks are indicated herein by capitalization.

The following definitions include inflected forms of the defined terms.

The term “tablet” as used herein means a mass of solid material, usually compacted, compressed, molded, or extruded, of various physical forms such as a caplet, gelcap, briquette, disk, block or discrete unit. The term “biocide” as used herein means bactericide, virucide, or both. The term “polyoxyethylene” as used herein means a composition including the monomer represented by the general formula,
—[—CH₂-CH₂—O—]ₙ—
and which is also known in the literature as poly(ethylene oxide), poly(oxyethylene), or poly(ethylene glycol).

The present invention provides an easily dissolvable composition, in tablet form, of a broad-spectrum biocide acting through chlorine/hypochlorite generation. The tablet form is especially beneficial for storage and portability.

The composition is particularly useful in animal and human health applications and has the following properties: stability in tablet form; good solubility when tablet is dissolved in water; resistant to inactivation by organic matter generally encountered in animal and human health situations; low sulfamic acid content; safe in animal health situations in relation to effect on livestock; high virucidal effect under government-approved testing schemes; odorless, non-irritant and resistant to loss of activity from solvation in hard water; optimal virucidal and bactericidal activity when used in farm environments. The tablet form provides advantages of reduction or even elimination of dusting, facilitated dosing, and no clogging of trigger spray packs due to poorly soluble packaging of powders.

The biocidal composition of this invention comprises, in tablet form, (a) 0.01 to 5 parts by weight of a water soluble inorganic halide, (b) 25 to 60 parts by weight of an oxidizing agent, (c) 3 to 8 parts by weight of sulfamic acid, (d) up to 10 parts by weight of an anhydrous alkali metal phosphate, (e) 5 to 25 parts by weight of a water-soluble carbonate or bicarbonate, and (f) a non-reducing organic acid in an amount sufficient that the pH of a 1% by weight aqueous solution of the composition is between 1.5 and 3.5; the parts by weight of the composition totaling 100, wherein a 5 gram tablet of the composition dissolves in 500 ml of water in less than 8 minutes at ambient temperature.

The tablets are easy to dissolve in polar solvents. Water is the preferred solvent, but other polar solvents may be used, particularly where the solvent has disinfecting or other desirable properties and a combination of the properties of the solvent and those of the composition may be advantageous. “Easy to dissolve,” means, by way of illustrative example, that a tablet of the inventive composition weighing 5 grams will dissolve in 500 ml of water in less than about 8 minutes, preferably less than about 5 minutes at ambient temperature. By “ambient temperature” is typically meant no heating is involved in dissolving the tablet. Ambient temperature is typically about room temperature, that is, about 20-25° C. It should be recognized that the tablet will dissolve faster at higher temperatures. As discussed below, compositions, or solutions of compositions, of the invention may include additives such as surfactants and binders. Solutions may be usefully applied by any means known to transmit a liquid to a surface, including, by way of illustration, spray bottles or aerosol formulations.

A tablet of this invention also provides a stable solution once dissolved. “Stable solution” means, by way of example, that a 1% solution prepared from a tablet of this invention retains 70% or more actives over 7 days. “Actives” refers to total oxidizing species as determined by AVOX/iodometric titration, or other suitable method, that is, oxidizing power. In this method, oxidizing power of products is conveniently measured in terms of the amount of iodine liberated by reaction with potassium iodide (determined by a subsequent titration of that iodine). The procedure is standard in the art, and the results can be expressed in terms of available hypohalite, of halogen, or of oxygen, or simply as “oxidizing power”.

The preferred inorganic halide is sodium chloride, with the preferred range of amounts being from 0.01 to 5 parts by weight, especially from 0.2 to 2 parts by weight when the composition is dissolved in water from normal domestic water supply. However, other halides can be used, for example, alkali metal halides where the alkali metal is sodium or potassium and the halide is chloride, bromide or iodide.

The oxidizing agent, which is advantageously employed in an amount of from 25 to 60 parts by weight, is conveniently a persulfate or peroxyphthalate (particularly potassium monoperoxyphthalate). The preferred oxidizing agent is, however, the commercially available potassium peroxymonosulfate triple salt approximately represented by 2 KHSO₅*KHSO₄*K₂SO₄ (in weight terms 45:25:30), which is available from E. I. du Pont de Nemours and Company, Wilmington, Del. under the trade name of OXONE. Other oxidizing agents can be used in amounts equivalent in terms of available oxidizing power.

The sulfamic acid is used as a halogen acceptor, in an amount from 3 to 8 parts by weight. In contrast to WO 91/03936, sulfamic acid is not used as an acid to react with the carbonate/ bicarbonate to generate carbon dioxide. It has been surprisingly found that too much sulfamic acid results in poor solubility of the tablets and poor solution stability of the dissolved tablet solution. By “poor solubility” it is meant a tablet composition weighing 5 grams will not dissolve in 500 ml of water in less than about 8 minutes at ambient temperature. Similarly, by “poor solution stability” or “poor stability” it is meant that a 1% solution prepared from a tablet of this invention retains less than 70% actives over 7 days.

A non-reducing organic acid is added to control pH in the presence of a carbonate or bicarbonate, which enables effervescence. A non-reducing organic acid is defined as an organic acid that does not reduce the oxidizing power of a 1% aqueous solution of a test mixture of 50 parts by weight of the potassium peroxymonosulfate triple salt referred to above, 45 parts of sodium chloride and 5 parts by weight of sulfamic acid with the addition of 20 parts by weight test acid, when left for thirty minutes. The preferred organic acids are malic acid and succinic acid.

The non-reducing organic acid is present in an amount sufficient that the pH of a 1% by weight aqueous solution of the composition is between 1.5 and 3.5. Preferably the pH is greater than 2.5. Preferably the pH is less than 3.4. The precise amount of the organic acid can be readily determined by one skilled in the art based on the amounts of other components added which affect pH. Depending on the pH, the amount of organic acid may be greater than 20 parts by weight of the composition.

The alkali metal phosphate may be sodium hexametaphosphate (also known as sodium polyphosphate). Other phosphates, which can be used to replace all or part of the sodium hexametaphosphate can be selected from the group consisting of tetrasodium pyrophosphate, mono-, di- and tri-sodium phosphate, and the corresponding potassium compounds. The phosphate acts as a buffering and chelating agent and enables the composition to be effective over a wide-range of in-use conditions. For example, the composition can be dissolved in hard water and even in seawater without deleteriously affecting its bactericidal and virucidal properties. An effective amount of alkali metal phosphate is up to about 10 parts by weight. The phosphate is preferably present in an amount of about 2 to 7 parts by weight.

The carbonate or bicarbonate is conveniently employed in an amount of from 5 to 25 parts by weight, and of the many typical carbonates and bicarbonates, alkali metal bicarbonates are preferred. Sodium bicarbonate is typically satisfactory. The carbonate or bicarbonate is added to assist in disintegration and solubilization of the tablet.

To improve various properties, the composition of this invention may further comprise a number of additional components, for example, surfactants, binders, disintegration aids, drying agents, coloring aids and the like. The total amount of additional components is typically from about 0 to about 25 parts by weight.

Any surfactant compatible with the acids and oxidizing agents can be utilized. Suitable surfactants can be selected from the group consisting of sodium dodecylbenzene sulfonate, lauryl ether sulfates, ethylene oxide/propylene oxide alkyl phenol condensates, polyglycol ethers of fatty alcohols, fatty acid ethylene oxide condensates, polyglycol ethers of alkyl phenols, and fatty alcohol ethoxylates. Sodium dodecylbenzene sulfonate has been found to be a particularly effective surfactant. Surfactant(s) can be added as soluble solid components of the tablet, as component(s) of a solvent, or both. The incorporation of a surfactant in the composition gives the important advantage, particularly at high surfactant levels, of enabling cleaning and disinfecting in a single operation. This is of considerable importance in the cleaning of poultry houses and other premises in which farm animals are housed. The surfactant may be present in an amount up to about 20 parts by weight.

To improve its tableting properties the effervescent composition of the invention may further comprise a binder capable of loosely bonding the particles together when compressed in a tablet press. The amount of binder used is preferably of the order of 0.5 to 2 parts by weight, and suitable binders are sodium stearate (a fatty acid soap), a polyoxyethylene (a polyglycol), or mixtures of the two.

The carbonate or bicarbonate, upon reaction with acid functions, acts as a disintegration aid. Other disintegration aids may also be used such as fumed silica, which also acts as a drying agent.

Colorants compatible with the end use may also be incorporated into the composition of this invention.

Tablets are prepared using conventional tableting processes and equipment. The ingredients are weighed, and can be sieved to reduce the size of any agglomerates. However, no initial granulation stage is required. The components are physically combined and mixed to form a blend. Tablets are made from the blend, for example, using direct compression methods. Thus, the blend may be supplied to the dies of a tableting press, and compressed into tablet form. Methods may be varied to deliver tablets of the desired size and hardness. In principle this is all conventional, and well known to those skilled in the art.

The formed tablets may be added to water at the point of use to form a disinfectant, biocidal aqueous composition of the required concentration, preferably immediately prior to use. However, since solutions of the tablet composition of this invention are more stable than those previously disclosed, these solutions may be stored for a time.

Solution preparations of the invention are broad-spectrum biocides, meaning that they are lethal to a wide range of pathogens and pathogenic agents including bacteria and viruses. Although the method of viral degradation is not known, it is believed that the lipoprotein cytoplasmic membrane or outer lipid protective layer of the virus is first disrupted, thereby destroying or disabling the means by which the virus may infect cells, and exposing the RNA or DNA nucleus of the virus to degradation or dispersal.

The sulfamic acid acts as a chlorine acceptor to retain nascent chlorine in solution as an addition product with the sulfamic acid thereby avoiding the evolution of chlorine gas. Maintenance of a low chloride or other halide concentration assists in this prevention of chloride evolution without reducing the bactericidal/virucidal efficacy of the composition.

In the aforementioned U.S. Pat. No. 4,822,512, details are given of the virucidal activity of a composition of that specification. Tests indicated that the incorporation of carbonate or bicarbonate, additional sulfamic acid and bonding agent has no significantly adverse effect on the bactericidal activity. However, it has been found that these components negatively affect solubility of the composition and stability of the solution. When a solution of the composition is to be used immediately, rate of solubility is important. When a solution of the composition will be stored, that is, not used immediately, solution stability is critical. The present invention provides a composition in tablet form that is an effective bactericide with virucidal activity. This tablet readily dissolves in polar solvents and once dissolved provides a stable solution.

The present invention further relates to uses of the compositions in disinfection of surfaces. A method for disinfecting surfaces comprises contacting a surface with an aqueous solution prepared from a tablet comprised of a composition of the invention, the composition comprising (a) 0.01 to 5 parts by weight of a water soluble inorganic halide, (b) 25 to 60 parts by weight of an oxidizing agent, (c) 3 to 8 parts by weight of sulfamic acid, (d) up to about 10 parts by weight of an anhydrous alkali metal phosphate, (e) 5 to 25 parts by weight of a water-soluble carbonate or bicarbonate, and (f) a non-reducing organic acid in an amount sufficient that the pH of a 1% by weight aqueous solution of the composition is between 1.5 and 3.5; the parts by weight of the composition totaling 100, wherein a 5 gram tablet of the composition dissolves in 500 ml of water in less than 8 minutes at ambient temperature. Compositions and methods of the invention are useful in any setting in which sanitary conditions are required or desired, including, by way of illustration, laboratories, medical care facilities, and food preparation areas. They may also be useful in residential settings (private or group residences, for example). Non-limiting examples of surfaces that can beneficially be disinfected include hard surfaces such as countertops, walls, floors, surfaces in hospitals, especially surfaces in hospital labs. Surfaces in animal health applications include treating those encountered in animal housing, including floors and walls, and in general, any location in which animals are housed, fed and handled, animal litter, and surfaces that may come into contact with animals. The composition of this invention can also be used to treat water systems used in animal environments, such as farms.

### EXAMPLES

### Examples 1-2 and Comparative Examples A-L

### Determination of Tablet Compositions

Compositions were prepared by mixing together the ingredients as specified and in the amounts as provided in Table 1. The compositions were prepared by first mixing together the phosphate and the sulfonate followed by addition of the oxidizing agent and the acids, finally, adding the sodium chloride. Solutions of the compositions were prepared at 1% by weight of all ingredients.

The oxidizing agent was potassium peroxymonosulfate, available from E. I. du Pont de Nemours and Company, Inc., sold under the tradename OXONE. The other ingredients were obtained from standard commercial sources. The surfactant was sodium dodecylbenzene sulfonate. The organic acid was malic acid. The phosphate was sodium hexametaphosphate. The colorant was Dyacid Red 9. The bicarbonate was sodium bicarbonate. In Table 1, “C. Ex.” denotes a Comparative Example and “Ex.” denotes an Example of this invention. “Poor sol.” denotes poor solubility as defined hereinabove. “Poor stability” denotes poor stability of the solution as defined hereinabove.

TABLE 1

| | C. Ex. | C. Ex. | C. Ex. | C. Ex. | C. Ex. | C. Ex. | C. Ex. | C. Ex. | C. Ex. | C. Ex. | C. Ex. | C. Ex. | | |
|---|---|---|---|---|---|---|---|---|---|---|---|---|---|---|
| Material | A | B | C | D | E | F | G | H | I | J | K | L | Ex. 1 | Ex. 2 |
| Oxidizing | 51 | 51 | 52 | 51 | 51 | 51 | 51 | 51 | 51 | 51 | 51 | 51 | 51 | 51 |
| Agent | | | | | | | | | | | | | | |
| Surfactant | 5 | 5 | 5 | 5 | 5 | 5 | 5 | 5 | 5 | 5 | 5 | 5 | 5 | 5 |
| Organic | 9 | 11 | 11 | 11 | 12 | 12 | 12 | 12 | 16 | 21 | 19.45 | 18 | 21 | 21 |
| Acid | | | | | | | | | | | | | | |
| Sulfamic | 5 | 5 | 5 | 6 | 5 | 6 | 7 | 9 | 5 | 6.45 | 5 | 6.45 | 6.45 | 5 |
| Acid | | | | | | | | | | | | | | |
| Phosphate | 15.45 | 15.45 | 15.45 | 15.45 | 15.45 | 15.45 | 15.45 | 13.45 | 13.45 | 7 | 10 | 10 | 2.5 | 4.95 |
| NaCl | 1.5 | 1.5 | 1.5 | 1.5 | 1.5 | 1.5 | 1.5 | 1.5 | 1.5 | 1.5 | 1.5 | 1.5 | 1.5 | 1.5 |
| Colorant | 0.05 | 0.05 | 0.05 | 0.05 | 0.05 | 0.05 | 0.05 | 0.05 | 0.05 | 0.05 | 0.05 | 0.05 | 0.05 | 0.05 |
| Bicarbonate | 13 | 11 | 10 | 10 | 10 | 9 | 8 | 8 | 8 | 8 | 8 | 8 | 12.5 | 11.5 |
| pH | 4.94 | 3.66 | 4.62 | 2.65 | 3.51 | 3.21 | 3.03 | 2.7 | 3.1 | 2.82 | 3.02 | 2.9 | 3.28 | 3.29 |
| Results | High | High | High | Poor | High | Poor | Poor | Poor | Poor | Poor | Poor | Poor | Good | Good |
| | pH | pH | pH | sol. | pH | sol. | sol. | stability | sol. | sol. | sol. | stability | | |

Based on the initial performance results as shown in Table 1, successful candidates were selected for preparation of tablet compositions. Compositions with poor solubility, poor stability and high pH were rejected.

### Example 3

### Tablet Composition and Testing

A biocidal composition was prepared by premixing surfactant sodium dodecylbenzene sulfonate with fumed silica and sodium stearate. The premix was bulk mixed with the remaining ingredients per Table 2. Tablets were made by direct compression, with a standard size of 5 grams.

TABLE 2

| | Composition |
|---|---|
| Material | (parts per 100) |
| Potassium peroxymonosulfate (OXONE) | 50 |
| Sodium Chloride | 1.5 |
| Sulfamic Acid | 6.45 |
| Sodium dodecylbenzene sulfonate | 5 |
| Malic Acid | 21 |
| Sodium Hexametaphosphate | 7 |
| FD&C Yellow No. 5 | 0.15 |
| Sodium Bicarbonate | 8 |
| Sodium Stearate | 0.8 |
| Fumed Silica | 0.4 |

Solutions prepared by dissolving the tablets in water were tested according standard AOAC microbiological testing procedures. A 5-gram tablet was dissolved in 500 ml of water for use in tests. AOAC Use-Dilution Method, DIS/TSS-1 Jan. 22, 1982, was followed for Staphylococcus aureus ATCC 6538 (for effectiveness against Gram-positive bacteria) and Salmonella choleraesuis ATCC 10708 (for effectiveness against Gram-negative bacteria). EPA test DIS/TSS-7/Nov. 12, 1981, was used to test virucidal activity on inanimate environmental surfaces. To simulate in-use conditions, the specific virus to be treated was inoculated onto a hard surface, allowed to dry, and then treated with the solution of the tablet. The solutions passed the criteria set forth in the AOAC procedures per Table 3.

TABLE 3

| Test | Organism | Strain | Result |
|---|---|---|---|
| AOAC Use- | S. Aureus | ATCC 6538 | Pass |
| Dilution | Salmonella choleraesuis | ATCC 10708 | Pass |
| EPA Virucidal | Poliovirus | Type 1 | Pass |
| Activity | | | |
| Inanimate | | | |
| environmental | | | |
| surfaces | | | |
| EPA Virucidal | Canine parvovirus | Cornell | Pass |
| Activity | | strain | |
| Inanimate | | | |
| environmental | | | |
| surfaces | | | |

As can be seen from the table, testing of the solutions prepared from the tablet composition of this invention, virucidal activity was shown to satisfy the AOAC and EPA tests.

### Example 4

Tablets were made according to Example 3, by direct compression, with standard sizes of 40 grams and 50 grams. The composition of the tablets was consistent in all respects with the composition of the 5 gram tablets as set forth in Example 3 and Table 2. The tablets dissolve readily in water, in under 8 minutes at ambient temperature, if mixed at a ratio of about 1 gram of solid composition to about 100 ml of solvent. This ratio is an approximate benchmark, and skilled practitioners in the art will appreciate that variations on this 1:100 ratio of solid to solvent are permissible and that at varied ratios the composition will dissolve readily in water and retain desired properties of stability and retention of biocidal activity over time.

What is claimed is:

1. A biocidal composition in a tablet form comprising
(a) 0.01 to 5 parts by weight of a water soluble inorganic halide;
(b) 25 to 60 parts by weight of an oxidizing agent;
(c) 3 to 8 parts by weight of sulfamic acid;
(d) up to 10 parts by weight of an anhydrous alkali metal phosphate;
(e) 5 to 25 parts by weight of a water-soluble carbonate or bicarbonate; and
(f) a non-reducing organic acid in an amount sufficient that the pH of a 1% by weight aqueous solution of the composition is between 1.5 and 3.5;
the parts by weight of the composition totaling 100, wherein a 5 gram tablet of the composition dissolves in 500 ml of water in less than 8 minutes at ambient temperature.

2. The composition of claim 1 wherein a 1% by weight aqueous solution of the tablet retains 70% or more actives over at least 7 days.

3. The composition of claim 1 wherein the inorganic halide is an alkali metal halide and the alkali metal is sodium or potassium and the halide is chloride, bromide or iodide.

4. The composition of claim 4 wherein the inorganic halide is sodium chloride.

5. The composition of claim 4 comprising about 0.2 to about 2 parts by weight of an inorganic halide.

6. The composition of claim 6 wherein the inorganic halide is sodium chloride.

7. The composition of claim 1 wherein the oxidizing agent is potassium peroxymonosulfate triple salt.

8. The composition of claim 1 wherein the organic acid is malic acid or succinic acid.

9. The composition of claim 1 wherein the alkali metal phosphate is sodium hexametaphosphate.

10. The composition of claim 10 comprising about 2 to about 7 parts phosphate by weight of the composition.

11. The composition of claim 1 wherein the carbonate or bicarbonate is sodium bicarbonate.

12. The composition of claim 1 wherein the inorganic halide is sodium chloride, the oxidizing agent is potassium peroxymonosulfate triple salt, the organic acid is malic acid or succinic acid, the alkali metal phosphate is sodium hexametaphosphate, and the carbonate or bicarbonate is sodium bicarbonate.

13. The composition of claim 1 further comprising at least one surfactant.

14. The composition of claim 14 comprising up to about 20 parts by weight of surfactant.

15. The composition of claim 15 wherein the surfactant is sodium dodecylbenzene sulfonate.

16. The composition of claim 1 further comprising a binder.

17. The composition of claim 17 wherein the binder is sodium stearate, polyoxyethylene, or mixtures thereof.

18. The composition of claim 17 comprising about 0.5 to about 2 parts by weight of a binder.

19. A biocidal solution comprising,
(a) a biocidal composition in a tablet form of claim 1; and
(b) at least one polar solvent.

20. The solution of claim 19 wherein at least one solvent is water.

21. The solution of claim 20 wherein the inorganic halide of the composition comprises an alkali metal halide and the alkali metal is sodium or potassium and the halide is chloride, bromide or iodide.

22. The solution of claim 21 wherein the inorganic halide is sodium chloride.

23. The solution of claim 20 wherein the oxidizing agent of the composition is potassium peroxymonosulfate triple salt.

24. The solution of claim 20 wherein the organic acid of the composition is selected from the group consisting of malic acid and succinic acid, the alkali metal phosphate of the composition is sodium hexametaphosphate, and the carbonate or bicarbonate of the composition is sodium bicarbonate.

25. The solution of claim 20 wherein the composition further comprises at least one surfactant.

26. The solution of claim 20 wherein the composition further comprises a binder.

27. The solution of claim 25 wherein at least one surfactant is sodium dodecylbenzene sulfonate.

28. The solution of claim 26 wherein the binder is sodium stearate, polyoxyethylene, or mixtures thereof.

29. A method for disinfecting surfaces comprising contacting a surface with a solution prepared from a composition in tablet form dissolved in at least one polar solvent, the composition comprising (a) 0.01 to 5 parts by weight of a water soluble inorganic chloride, (b) 25 to 60 parts by weight of an oxidizing agent, (c) 3 to 8 parts by weight of sulfamic acid, (d) up to about 10 parts by weight of an anhydrous alkali metal phosphate, (e) 5 to 25 parts by weight of a water-soluble carbonate or bicarbonate, and (f) a non-reducing organic acid in an amount sufficient that the pH of a 1% by weight aqueous solution of the composition is between 1.5 and 3.5; the parts by weight of the composition totaling 100, wherein a 5 gram tablet of the composition dissolves in 500 ml of water in less than 8 minutes at ambient temperature.
